(19) United States
(12) Patent Application Publication
(10) Pub. No.: US 2003/0107544 A1
(43) Pub. Date: Jun. 12, 2003

(54) Display devices and driving method therefor

(75) Inventor: Martin J. Edwards, Crawley (GB)

Correspondence Address: U.S. Philips Corporation, Corporate Patent Counsel, 580 White Plains Road, Tarrytown, NY, 10591, US

(73) Assignee: KONINKLIJKE PHILIPS ELECTRONICS N.V.

(21) Appl. No.: 10/191,333

(22) Filed: Jul. 9, 2002

(30) Foreign Application Priority Data
Dec. 7, 2001 (GB) 0117000.0

(51) Int. Cl. G09G 3/36

(52) U.S. Cl. 345/96

(57) ABSTRACT

Driving schemes are described in which rows (1 to m) are selected one at a time and column data voltages are inverted to provide inversion schemes for display devices comprising pixels (12) arranged in rows (1 to m) and columns (1 to n). The order in which rows are selected is such that a first plurality of successive rows (or groups of rows) of those rows (or groups of rows) to be driven with a first polarity are driven consecutively, followed by a first plurality of successive rows (or groups of rows) of those rows (or groups or rows) to be driven with a second polarity, followed by a second plurality of successive rows (or groups of rows) of those rows (or groups of rows) to be driven with the first polarity, and so on. The polarity is inverted less often, so saving power.

The present invention relates to display devices comprising pixels arranged in rows and columns, and to driving or addressing methods for such display devices. The present invention is particularly related to driving schemes in which column drive voltages are inverted to provide inversion schemes.

Liquid crystal display devices are well known, and usually comprise a plurality of pixels arranged in an array of rows and columns.

Conventionally the pixels are addressed or driven as follows. The rows of pixels are selected one at a time, starting with row one and working through the remaining rows in successive order, by application of a selection voltage. This is sometimes referred to as switching of the rows by means of a switching voltage. For display devices, e.g. active matrix liquid crystal display devices, where switching of the pixels is implemented using thin film transistors, such selecting or switching of individual rows is sometimes referred to as gating, as the switching voltage is applied to the gates of the transistors of the relevant row.

The pixels within the row currently selected are provided with respective display settings by virtue of respective data voltages being applied to each of the columns. Such data voltages are known by a number of names in the art, including data signals, video signals, image signals, drive voltages, column voltages, and so on.

Selection of each of the rows one by one, with driving of the columns as required during each row selection, provides display of one frame of the image being displayed. The display is then refreshed by a further frame being displayed in the same manner, and so on.

In addition, inversion schemes are implemented in many liquid crystal display devices. According to known inversion schemes, two different polarities of data voltage are employed (note these need not actually be positive and negative in an absolute sense, provided they produce opposite polarity voltages across the light modulating layer, e.g. liquid crystal layer, of the particular display device). Inversion schemes are employed to alleviate degradation of the liquid crystal material that would otherwise occur under continuous single-polarity operation.

Any given pixel has different polarities applied to it in different frames (usually alternating frames), i.e. the polarity for the pixel is inverted over time.

In addition, in some inversion schemes pixels are also inverted on a positional basis with respect to other pixels, as follows.

Considering first one column of pixels, different pixels are provided with different polarities. In a simple example, alternate pixels down the column are provided with different polarity of data voltage. This is performed by varying the polarity in time with the row selection procedure. Another possibility is for groups of consecutive pixels down the column, e.g. groups of two pixels, to be provided with inverted polarity compared to adjacent groups of two. In these examples, if all the columns are given the same distribution of drive voltage polarity (i.e. all the pixels in a row have the same polarity), the inversion scheme is known as a row inversion scheme. However, if additionally, in each row, adjacent pixels are provided with different polarity, then the inversion scheme is known as a pixel inversion scheme.

Thus in either pixel or row inversion schemes, the data voltages applied to a given column are inverted each time a new row (or each time the first row of a new group of adjacent rows) is selected. However, the use of such schemes disadvantageously involves increased power consumption since power is consumed each time the data voltage applied to a column is inverted.

It would therefore be desirable to provide an addressing scheme that retains the advantages of positional polarity inversion, but involves less consumption of power.

Many prior art display devices and driving schemes are known that vary in detail over the above discussed types. Such variations include variations in the order in which the rows are selected. Some of these prior art schemes are known as multi-field driving. The reference “Multi-Field Driving Method for Reducing LCD Power Consumption”, H. Okumura and G. Itoh, SID 95 DIGEST, 1995, pages 249-252, discloses a multi-field driving method. JP-A-06 004 045 discloses a driving scheme in which multiple odd groups of nonconsecutive rows being provided with a same data voltage polarity are selected in sequence, as opposed to all the rows being selected in row number order. In these prior art schemes, within a group of consecutive rows to be driven with a same polarity, some are selected on a first pass through the rows whereas some are only selected later in a further pass when the first pass of rows has been completed. As a result, in these schemes, rows that are closely spaced are selected at significantly different times in a frame, and this may lead to a problem of artefacts being present in moving images.

In a first aspect, the present invention provides a method of driving or addressing an array of pixels arranged in rows and columns, comprising selecting the rows and applying a drive voltage to the columns for each selected row, wherein the order in which the rows are selected is determined in relation to the polarity of the drive voltage to be applied for each row such that positionally successive rows of those rows which are to be driven with a first polarity but which are separated from each other by one or more rows to be driven with the second polarity are selected consecutively in time. Thereafter positionally successive rows of those rows which are to be driven with the second polarity are selected consecutively. Thereafter further positionally successive rows of those rows which are to be driven with the first polarity are selected consecutively. Thereafter further positionally successive rows of those rows which are to be driven with the second polarity are selected consecutively. This process of consecutively selecting positionally successive same-polarity rows is repeated until all the rows have been selected.

In a second aspect, the present invention provides a method of driving or addressing an array of pixels arranged in rows and columns, comprising selecting the rows and applying a drive voltage to the columns for each selected row, wherein the order in which the rows are selected is determined in relation to the polarity of the drive voltage to be applied for each row such that positionally successive rows to be driven with a same polarity are considered as groups of rows, and positionally successive groups of rows which are to be driven with a first polarity but which are separated from each other by one or more rows or groups of rows to be driven with the second polarity are selected consecutively in time. Thereafter positionally successive groups of those groups which are to be driven with the second polarity are selected consecutively. Thereafter positionally successive groups of those groups which are to be driven with the first polarity are selected consecutively. Thereafter positionally successive groups of those groups which are to be driven with the second polarity are selected consecutively. This process of consecutively selecting positionally successive same-polarity groups is repeated until all the groups have been selected.

In a third aspect, the present invention comprises display driver apparatus for driving an array of pixels arranged in rows and columns, comprising means for selecting the rows and applying a drive voltage to the columns for each selected row, arranged such that the order in which the rows are selected in relation to the polarity of the drive voltage to be applied for each row is such that positionally successive rows of those rows which are to be driven with a first polarity but which are separated from each other by one or more rows to be driven with the second polarity are selected consecutively in time.

In a fourth aspect, the present invention comprises display driver apparatus for driving an array of pixels arranged in rows and columns, comprising means for selecting the rows and applying a drive voltage to the columns for each selected row, arranged such that the order in which the rows are selected in relation to the polarity of the drive voltage to be applied for each row is such that positionally successive rows to be driven with a same polarity are considered as groups of rows, and positionally successive groups of rows which are to be driven with a first polarity but which are separated from each other by one or more rows or groups of rows to be driven with the second polarity are selected consecutively in time.

Thus, the order in which rows are selected is such that plural successive rows (or groups of rows) of those rows (or groups of rows) to be driven with a first polarity are driven consecutively, followed by plural successive rows (or groups of rows) of those rows (or groups or rows) to be driven with the second polarity being driven consecutively.

Accordingly, for any given column, the polarity needs to be inverted less often, thus tending to provide a saving in power consumption, whilst retaining all, or at least some, of the benefits of the polarity inversion scheme being applied.

The above described and other aspects of the invention will be apparent from and elucidated with reference to the embodiments described hereinafter.

Embodiments of the present invention will now be described, by way of example, with reference to the accompanying drawings, in which:

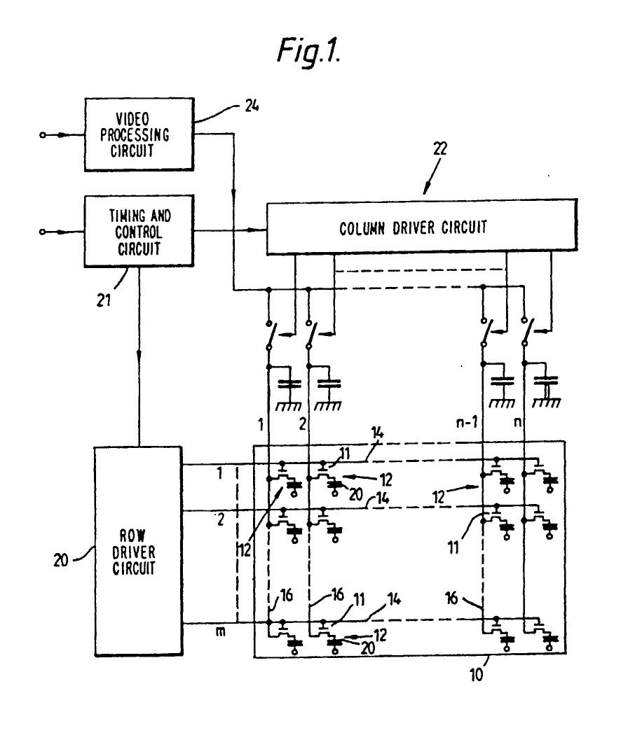

FIG. 1 is a schematic diagram of an active matrix liquid crystal display device in which a first embodiment of the invention is implemented;

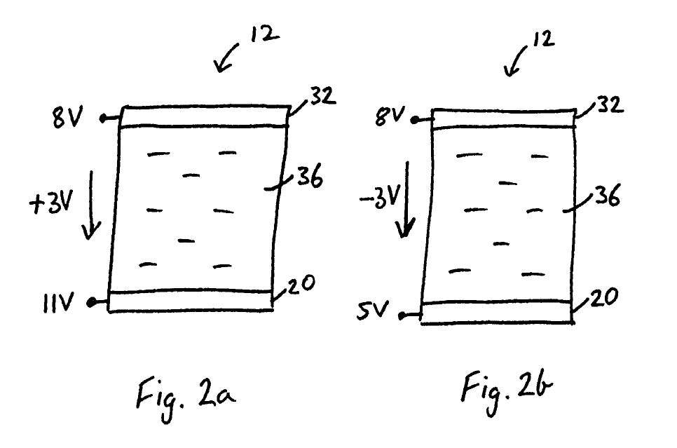

FIG. 2a shows a positive polarity data voltage being applied to a pixel of the display device of FIG. 1;

FIG. 2b shows a negative polarity data voltage being applied to the same pixel of the display device of FIG. 1;

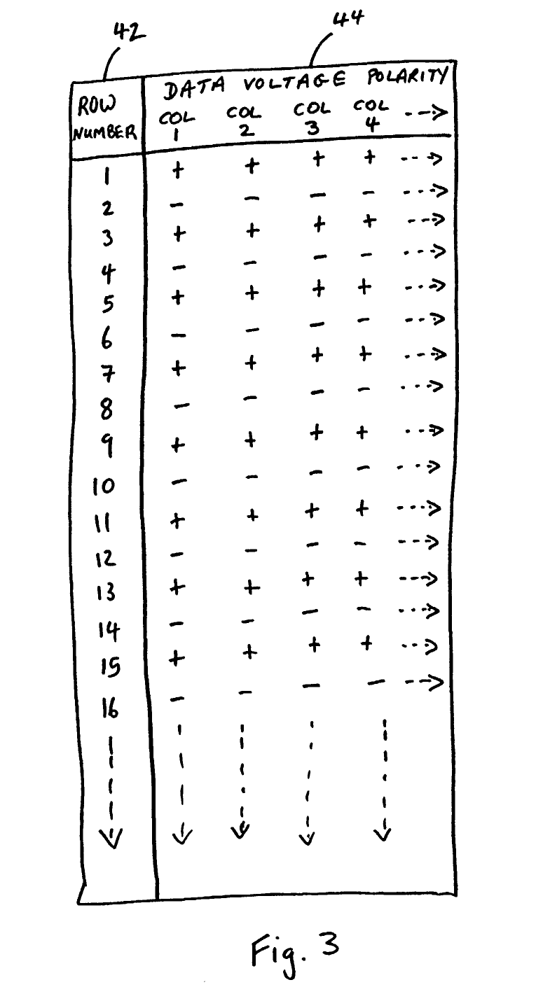

FIG. 3 shows a row inversion scheme applied to the display device of FIG. 1;

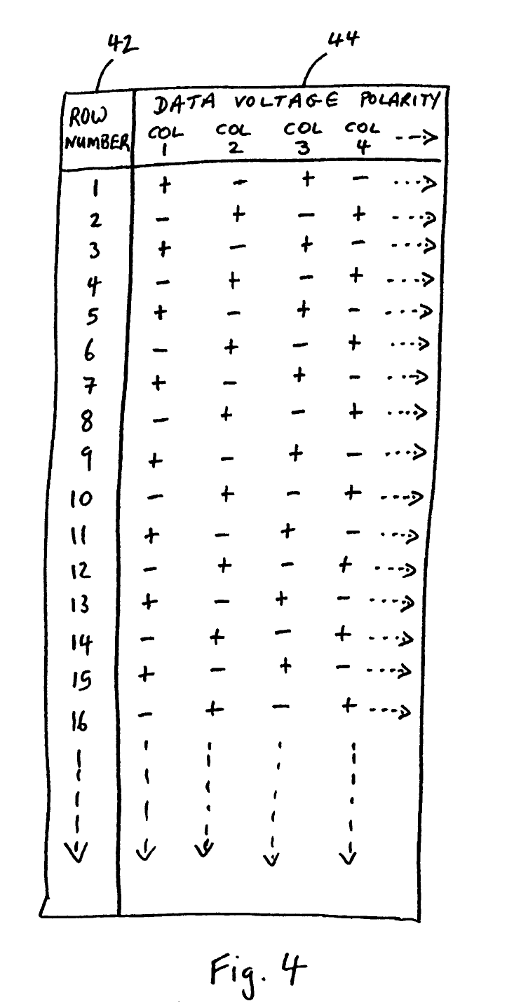

FIG. 4 shows a pixel inversion scheme applied to the display device of FIG. 1;

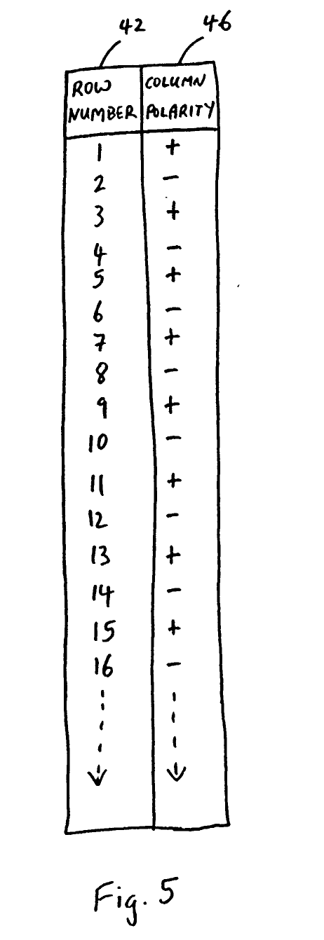

FIG. 5 shows, for one frame, the polarity of data voltage for the first column of the display device of FIG. 1 as applied to each row number, in the inversion schemes of FIGS. 3 and 4;

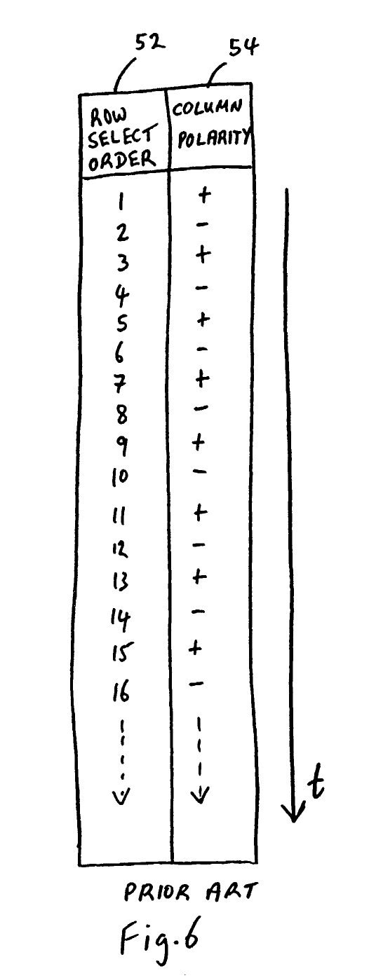

FIG. 6 shows the resulting polarities applied to the first column over time as the rows of FIG. 5 are selected according to prior art row selection ordering;

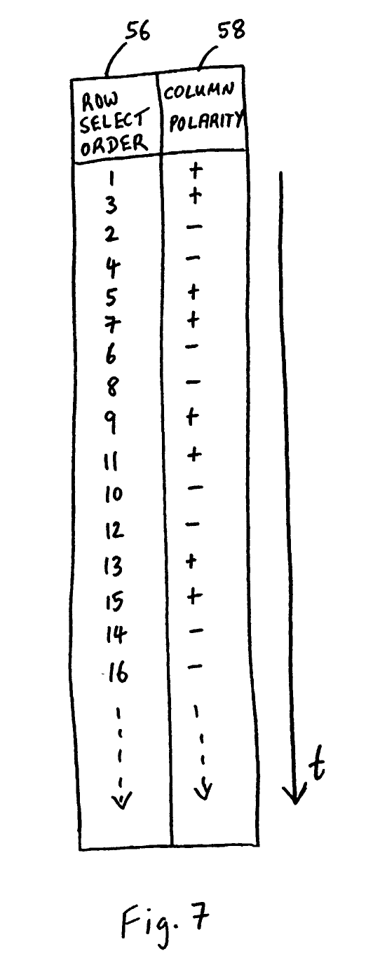

FIG. 7 shows the order of selection of the rows against time in an embodiment of the invention, and the resulting applied data voltage polarity for the first column against time;

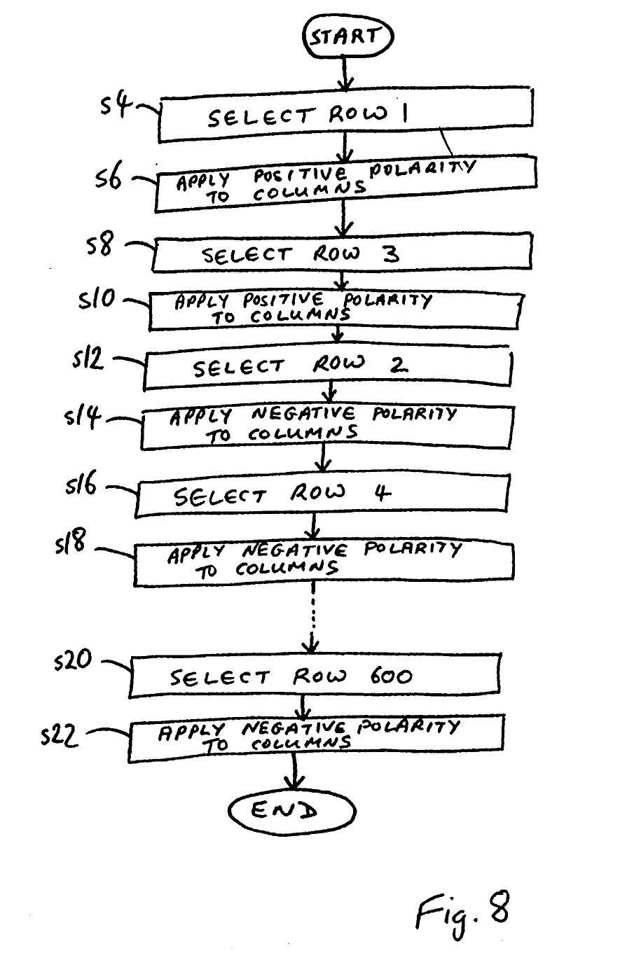

FIG. 8 is a flowchart showing process steps carried out by display driver apparatus in an embodiment of the invention;

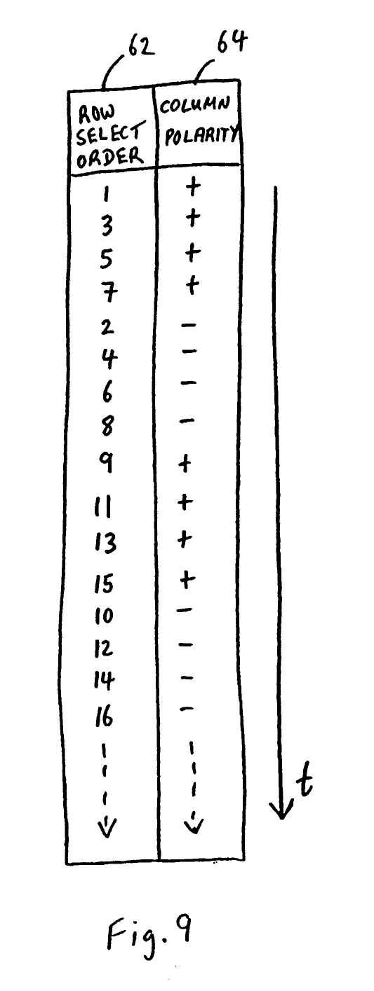

FIG. 9 shows the order of selection of the rows against time in another embodiment, and the resulting applied data voltage polarity for the first column against time;

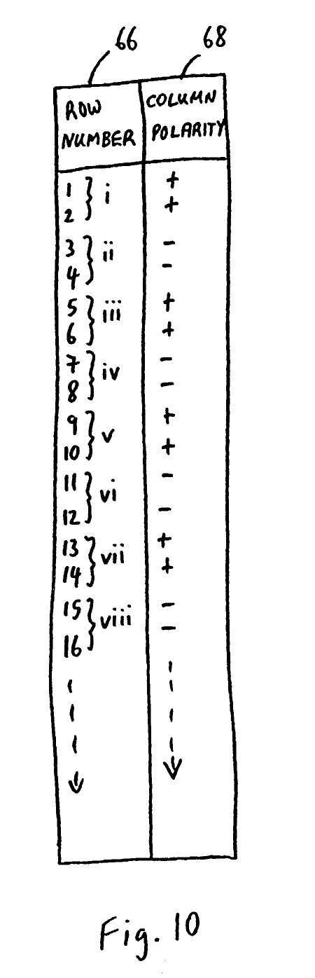

FIG. 10 shows, for one frame, the polarity of data voltage for the first column of the display device of FIG. 1 as applied to each row number, in a further inversion scheme;

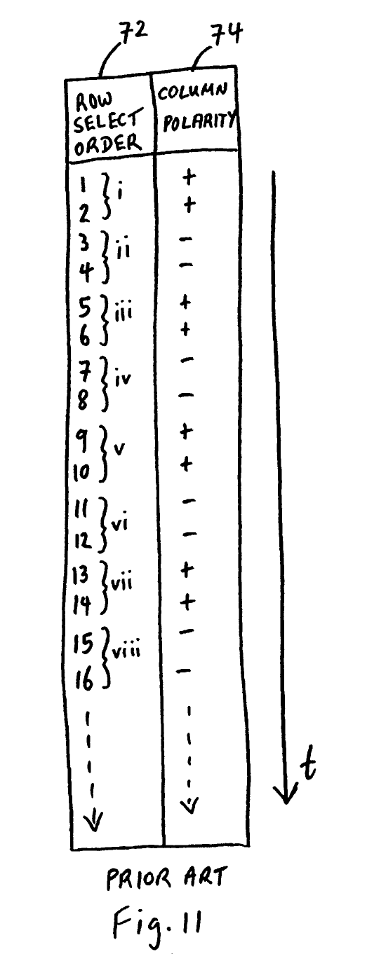

FIG. 11 shows the resulting polarities applied to the first column over time as the rows of FIG. 10 are selected according to prior art row selection ordering; and

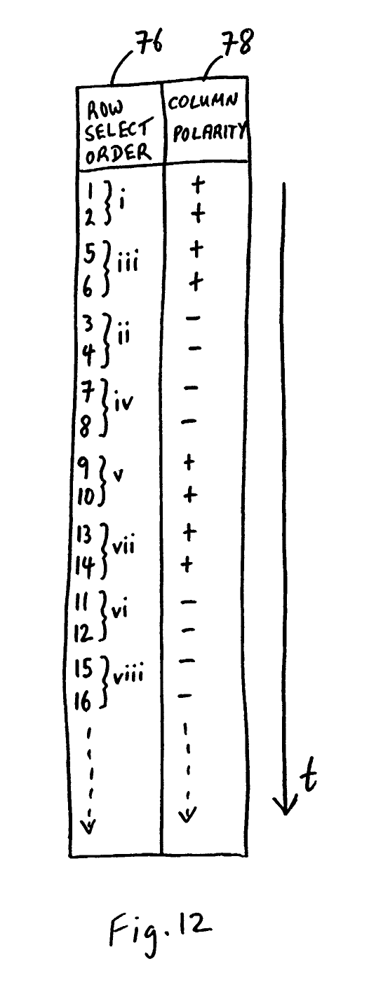

FIG. 12 shows the order of selection of the rows against time in yet another embodiment, and the resulting applied data voltage polarity for the first column against time.

FIG. 1 is a schematic diagram of an active matrix liquid crystal display device in which a first embodiment of the invention is implemented. The display device, which is suitable for displaying video pictures, comprises an active matrix addressed liquid crystal display panel 10 having a row and column array of pixels which consists of m rows (1 to m) with n horizontally arranged pixels 12 (1 to n) in each row. Only a few of the pixels are shown for simplicity.

Each pixel 12 is associated with a respective switching device in the form of a thin film transistor, TFT, 11. The gate terminals of all TFTs 11 associated with pixels in the same row are connected to a common row conductor 14 to which, in operation, selection (gating) signals are supplied. Likewise, the source terminals associated with all pixels in the same column are connected to a common column conductor 16 to which data (video) signals are applied. The drain terminals of the TFTs are each connected to a respective transparent pixel electrode 20 forming part of, and defining, the pixel. The conductors 14 and 16, TFTs 11 and electrodes 20 are carried on one transparent plate while a second, spaced, transparent plate carries an electrode common to all the pixels (hereinafter referred to as the common electrode). Liquid crystal is disposed between the plates.

The display panel is operated in conventional manner. Light from a light source disposed on one side enters the panel and is modulated according to the transmission characteristics of the pixels 12. The device is driven one row at a time by scanning the row conductors 14 with a selection (gating) signal so as to turn on the rows of TFTs in turn and applying data (video) signals to the column conductors for each row of picture display elements in turn as appropriate and in synchronism with the selection signals so as to build up a complete display frame (picture). The order in which the rows are selected during the scanning will be described below. Using one row at time addressing, all TFTs 11 of the selected row are switched on for a period determined by the duration of the selection signal corresponding to a TV line time during which the video information signals are transferred from the column conductors 16 to the pixels 12. Upon termination of the selection signal, the TFTs 11 of the row are turned off for the remainder of the frame period, thereby isolating the pixels from the conductors 16 and ensuring the applied charge is stored on the pixels until the next time they are addressed in the next frame period.

The row conductors 14 are supplied in their order of selection with selection signals by a row driver circuit 20 comprising a digital shift register controlled by regular timing pulses from a timing and control circuit 21. In the intervals between selection signals, the row conductors 14 are supplied with a substantially constant reference potential by the drive circuit 20. Video information signals are supplied to the column conductors 16 from a column driver circuit 22, here shown in basic form, comprising one or more shift register/sample and hold circuits. The circuit 22 is supplied with video signals from a video processing circuit 24 and timing pulses from the circuit 21 in synchronism with row scanning to provide serial to parallel conversion appropriate to the row at a time addressing of the panel 10.

Other details of the liquid crystal display device, except where otherwise stated below in relation to the order in which the rows are selected in relation to their column polarity, may be as per any conventional active matrix liquid crystal display device, and are in this particular embodiment the same as, and operate the same as, the liquid crystal display device disclosed in U.S. Pat. No. 5,130,829, the contents of which are contained herein by reference.

The way in which the data voltage, as applied to the columns, is varied between two polarities, will now be explained with reference to FIGS. 2a and 2b. FIGS. 2a and 2b each show schematically (not to scale) an above mentioned pixel 12, formed (inter-alia) from a pixel electrode 20, the (corresponding portion of) the above mentioned common electrode (indicated by reference numeral 32 in FIGS. 2a and 2b), and (the corresponding portion of) the liquid crystal layer therebetween (indicated by reference numeral 36 in FIGS. 2a and 2b).

The common electrode 32 is maintained at a constant reference voltage, in this example 8V, as shown in both FIGS. 2a and 2b. FIG. 2a shows the case when a positive polarity data voltage is applied to the pixel. In this example a voltage of 11 v is applied to the pixel electrode 20, as shown, providing a potential difference across the liquid crystal layer of +3V (referenced to the common electrode 32). In this example, this is the positive polarity. In a grey scale display the magnitude of this potential difference provides the relevant grey scale, due to voltage magnitude dependence of the electro-optic effect of the light modulating layer, i.e. the liquid crystal layer 36. However, if the display were binary, then the magnitude of the potential difference would simply correspond to a fully on state.

FIG. 2b shows the case when a negative polarity data voltage is applied to the pixel. More particularly, the situation shown is when the same magnitude (3V) of potential difference is required as was applied in the FIG. 2a example. Thus in this case a voltage of 5V is applied to the pixel electrode, resulting in the required −3V potential difference across the liquid crystal layer (referenced to the common electrode 32).

It is noted that in both FIGS. 2a and 2b the voltage applied to the pixel electrode 20 is, in an absolute sense, positive. However, the 5V signal provides a negative polarity across the liquid crystal layer 36, whereas the 11V signal provides a positive polarity across the liquid crystal layer 36. Thus, in this specification, the terminology positive and negative polarity of data voltage is to be understood to include examples such as those described with reference to FIGS. 2a and 2b, as well as other examples where, say, the common electrode is held at 0V, and the positive and negative polarity applied data voltages are indeed positive and negative in an absolute sense as well as in the sense of the resulting potential drop across the light modulating layer.

Also, although in the example shown in FIGS. 2a and 2b, the common electrode 32 is held at a d.c. potential (here 8V), in other drive schemes (known as common electrode drive schemes) the common electrode is driven with an inverting square waveform, and the present invention may equally be implemented with such schemes.

This embodiment may be applied to either a row inversion scheme or a pixel inversion scheme. It is convenient to first describe in more detail what is meant by these. FIG. 3 shows a row inversion scheme applied to the above described device. FIG. 3 shows, for one frame, the polarity (+or − as indicated) of data voltage (reference numeral 44) for each of the columns of the above described device (for clarity only the first four columns are shown) as applied to each row number (reference numeral 42) (for clarity only the first 16 rows are shown). For column 1, row 1 is positive, and thereafter the polarity is alternated for successive rows, i.e. row 2 is negative, row 3 is positive, and so on. All the other columns, e.g. columns 2, 3 and 4 as shown, have the same polarities for the same rows as per column 1. Thus, as can be seen, any given row has the same polarity across all the columns, i.e. the inversion takes place on a row basis, hence the terminology “row inversion” is used to describe this arrangement.

FIG. 4 on the other hand shows a pixel inversion scheme applied to the above described device. FIG. 4 also shows, for one frame, the polarity (+or − as indicated) of data voltage (reference numeral 44) for each of the columns of the above described device (for clarity only the first four columns are shown) as applied to each row number (reference numeral 42) (for clarity only the first 16 rows are shown). For column 1, row 1 is positive, and thereafter the polarity is alternated for successive rows, i.e. row 2 is negative, row 3 is positive, and so on. So far this is the same as per FIG. 3. However, as shown in FIG. 4, for column 2, the positive and negative polarities are reversed compared to column 1, This pattern is repeated for alternating columns, i.e. column 3 is the same as column 1, column 4 is the same as column 2, and so on. Thus, as can be seen, any two neighbouring pixels are of opposite polarity, hence the terminology “pixel inversion” is used to describe this arrangement.

In another form of pixel inversion, applied to some colour liquid crystal displays, three adjacent columns (one for each of the colours red, blue and green) have a first polarity for a given row, then the next three adjacent columns have the other polarity, and so on.

The situation for each of the above described row or pixel inversion schemes has been explained in terms of the polarities applied in one frame. In the next frame, the positive polarities and negative polarities are reversed.

The present embodiment may be applied equally to any of the above described row or pixel inversion schemes. For clarity, the effect of the row selection method to be described will be explained in terms of column 1 (e.g. of FIGS. 3 and 4) only. Thus, for completeness, FIG. 5 shows, for one frame, the polarity (+or − as indicated) of data voltage (reference numeral 46) for column 1 of the above described device as applied to each row number (reference numeral 42).

Before describing the row selection ordering of the present embodiment, it is convenient to first show the prior art order of selection of the rows of FIG. 5. In conventional devices, the rows are selected in simple succession according to their row number, i.e. position down the display. Thus, in each frame, row 1 is selected first, then row 2, then row 3, and so on. FIG. 6 shows the resulting polarities applied to column 1 over time as the rows are selected according to conventional row selection ordering. Referring to FIG. 6, when in the prior art the rows are selected simply in positional order, the row selection order (reference numeral 52) against time (t) simply follows the row number arrangement (i.e. reference numeral 42 shown in FIG. 5), and consequently in the prior art approach the applied data voltage polarity for column 1 (reference numeral 54) against time (t) changes on a row by row basis from positive to negative. Thus for each column, the polarity must be switched each time a new row is selected, hence additional power must be consumed each time a new row is selected.

Returning now to the present embodiment, this provides a different order of selection of the rows compared to that described above. FIG. 7 shows the order of selection of the rows (reference numeral 56) against time (t) in this embodiment, and the resulting applied data voltage polarity for column 1 (reference numeral 58) against time (t). Referring to FIG. 7, the rows are selected such that the first two rows of those that will be positive polarity (cf. FIG. 5), i.e. rows 1 and 3, are selected consecutively, then the first two rows of those that will be negative polarity (cf. FIG. 5), i.e. rows 2 and 4, are selected consecutively, then the next two rows of those that will be positive polarity (cf. FIG. 5), i.e. rows 5 and 7, are selected consecutively, then the next two rows of those that will be negative polarity (cf. FIG. 5), i.e. rows 6 and 8, are selected consecutively, and so on. Referring to FIG. 7, it can be seen that the resulting applied data voltage polarity for column 1 (reference numeral 58) against time (t) requires the polarity to be switched only every second time a new row is selected, thus conserving half the power consumed in the prior art arrangement by switching polarity.

In the arrangement shown in FIG. 1, the row driver circuit 20, the timing and control circuit 21, the column driver circuit 22 and the video processing unit 24 may together be considered to form a display driver apparatus. Such a display driver apparatus may be adapted in any suitable manner to implement the row selection ordering of this embodiment. For example, the row driver circuit 20 may be programmed to select the rows in the order described above, the column driver circuit may be adapted to switch the column polarities as described, and the video processing circuit may be adapted by provision of a buffer or memory (not shown) for storing video data for those rows not selected in their numerical order, i.e. the buffer may store the video data for row 2 whilst row 3 is selected, then use the stored video data when row 2 is later selected after row 3.

FIG. 8 is a flowchart showing process steps carried out by the display driver apparatus in this embodiment to provide, for a single frame, the row ordering and resulting polarities shown in FIG. 7, for the row inversion case.

At step s4, row 1 is selected by the row driver circuit 20 applying a selection voltage to row 1. At step s6, a positive polarity data voltage is applied to each column. This is implemented as follows. A video signal (i.e. specifying the magnitude of the data voltage to be applied to each column) is provided by the video processing circuit 24 and effectively sampled at the correct time for each column by virtue of the column driver circuit 22 connecting the video signal to the respective columns at the right times, under timing control of the timing and control circuit 21. Whether the polarity is positive or negative is controlled and implemented by a combination of the column driver circuit 22 and the video processing circuit 24 under the control of the timing and control circuit 21.

If the column driver circuit 22 is only implementing row and field inversion it may be supplied with video signals from the video processing circuit 24 which are inverted in polarity either every field (frame) or every field (frame) and every row. In this case the video processing circuit 24 carries out the switching between the two drive voltage polarities.

If the column driver circuit 22 is implementing pixel inversion then the video processing circuit 24 supplies the column driver circuit 22 with two sets of video signals. At any moment in time one of these sets is positive and the other negative. Signals from one or other of these two sets of inputs are directed to alternate columns in the display in order to provide the required drive polarities. The video processing circuit 24 may swap over the polarity of these two sets of signals row by row and at the end of each field, although this function may also be integrated into the column driver circuit 22.

At step s8, the next row is selected, namely row 3, as this is the second consecutive row of those rows having positive polarity applied thereto. At step s10, a positive polarity data voltage is applied to each of the columns.

In this embodiment, (only) two consecutive rows of those rows having positive polarity applied to them are selected consecutively, and thereafter two rows of those having negative polarity applied to them are selected. Hence, at step s12, row 2 is selected; at step s14, a negative polarity data voltage is applied to the columns; at step s16, row 4 is selected; and, at step s18, a negative polarity data voltage is applied to the columns.

This process is repeated, with pairs of odd-numbered rows being selected and having positive polarity data voltage applied followed by pairs of even-numbered rows being selected and having negative polarity data voltage applied, until at step s20 the last (mth) row, (in this embodiment, where the display has say 600 rows by 800 columns, row 600), is selected, and at step s22 a negative polarity data voltage is applied to the columns. This completes addressing of this frame. (During addressing of the next frame, the positive and negative polarities are reversed in steps s6, s10, s14 etc.)

In the above described process, the row is selected (e.g. step s4) then the voltage is applied to the column (e.g. step s6). Alternatively, this order may be reversed. Whichever order is used, it is necessary for the column voltage to be held until after the row has been deselected.

In the above described embodiment, the number of successive rows being driven with the same polarity that are selected consecutively is two (e.g. row 1 and row 3). However, in other embodiments, this number may be chosen to be more than two, as required. The larger the number, the less often the polarity needs to be switched per column, and hence the greater the power saving. However, a trade-off is involved, because when a larger number is chosen, the other polarity rows receive their selection later, and hence moving image artefacts may be introduced. Also, the drive circuitry and/or missing row data buffer become more complicated. Thus, the number may be chosen as required by the skilled person in view of these trade-offs according to the particular circumstances under consideration.

One preferred alternative embodiment that provides an overall four-fold power saving without significantly introducing moving image artefacts is shown in FIG. 9, which again shows the order of selection of the rows (here reference numeral 62) against time (t), and the resulting applied data voltage polarity for column 1 (here reference numeral 64) against time (t). In this embodiment, the number of successive rows being driven with the same polarity that are selected consecutively is four. In more detail, the rows being driven with the same (positive) polarity are the odd-numbered rows (see FIG. 5). Of these, the first four consecutive ones, namely rows 1, 3, 5 and 7 are selected consecutively. The next rows to be selected are rows 2, 4, 6 and 8, i.e. the first four consecutive ones of those rows of the same (negative) polarity, i.e. the even-numbered rows. The next rows to be selected are then the next four odd-numbered (i.e. positive polarity) rows, namely rows 9, 11, 13 and 15. The next rows to be selected are then the next four even-numbered (i.e. negative polarity) rows, namely rows 10, 12, 14 and 16, and so on.

In the above embodiments, the row or pixel inversion schemes are ones (see FIGS. 3, 4 and 5) in which the polarity to be applied is varied in any given column on a single row by single row basis, i.e. they may conveniently be termed “single row by single row” inversion schemes. However, other row or pixel type inversion schemes are known in which the polarity to be applied in any given column is varied for different rows, but on a basis other than single row by single row alternation. One such example is shown in FIG. 10, which shows, for one frame, the polarity (+or 1 as indicated) of data voltage (reference numeral 68) for column 1 of the above described device as applied to each row number (reference numeral 66).

As shown in FIG. 10, under this alternative inversion scheme, the first two consecutively numbered (i.e. adjacently positioned) rows (e.g. rows 1 and 2) have the first polarity (e.g. positive polarity) applied, then the next two numbered rows (rows 3 and 4) have the other polarity (negative polarity), then the next two numbered rows (rows 5 and 6) have the first polarity (positive polarity), then the next two numbered rows (7 and 8) have the other polarity (negative polarity), and so on. As with the inversion scheme of FIG. 5, the other columns may be the same as column 1, or may be such that even-numbered columns have opposite polarity for a given row compared to the odd-numbered columns. In general, the inversion scheme shown in FIG. 10 is known as “double row inversion” and is particularly employed in liquid crystal devices that have a delta colour filter arrangement in which the pixels in alternate rows of the display are offset horizontally by 1.5 times the column pitch. This arrangement may be used for displaying TV images rather than computer text because it gives a higher perceived horizontal resolution for a given number of columns than the vertical stripe colour filter arrangement that is used for computer displays. For convenience, we will call herein any such inversion scheme, in which inversion occurs in relation to groups of consecutive rows as opposed to single rows, “group of rows by group of rows” inversion schemes.

The way in which the present invention is embodied in the case of “group of rows by group of rows” inversion schemes such as that shown in FIG. 10 is indeed most readily described by considering the above described “consecutively numbered rows having a same polarity” as groups of rows. Thus, as shown in FIG. 10, rows 1 and 2 form a first group i, rows 3 and 4 form a second group ii, rows 5 and 6 form a third group iii, rows 7 and 8 form a fourth group iv, and so on. In other words, successive groups of rows (i, ii, iii etc), each comprising two successive rows (e.g. row 1 and row 2), are driven with a different polarity of data voltage (e.g. group i is driven with positive polarity, whereas group ii is driven with negative polarity).

Before describing the row selection ordering of the present embodiment, it is again convenient to first show the effect of using the prior art order of selection of the rows. In conventional devices, the rows are selected in simple succession according to their row number, i.e. position down the display. Thus, in each frame, row 1 is selected first, then row 2, then row 3, and so on. FIG. 11 shows the resulting polarities applied to column 1 over time as the rows are selected according to conventional row selection ordering. Referring to FIG. 11, when in the prior art the rows are selected simply in positional order, the row selection order (reference numeral 72) against time (t) simply follows the row number arrangement (i.e. reference numeral 66 shown in FIG. 5), and consequently in the prior art approach the applied data voltage polarity for column 1 (reference numeral 74) against time (t) changes on a group by group basis from positive to negative. Thus for each column, the polarity must be switched each time the first row of a new group is selected, hence additional power must be consumed each time the first row of a new group is selected.

Returning now to the present embodiment, this provides a different order of selection of the rows for the inversion scheme shown in FIG. 10 compared to the prior art order shown in FIG. 11. FIG. 12 shows the order of selection of the rows/groups (reference numeral 76) against time (t) in this embodiment, and the resulting applied data voltage polarity for column 1 (reference numeral 78) against time (t). Referring to FIG. 12, the rows are selected such that the first two groups of rows of those groups that will be positive polarity (cf. FIG. 10), i.e. groups i and iii, are selected consecutively, then the first two groups of rows of those groups that will be negative polarity (cf. FIG. 10), i.e. groups ii and iv, are selected consecutively, then the next two groups of those that will be positive polarity (cf. FIG. 10), i.e. groups v and vii, are selected consecutively, then the next two groups of those that will be negative polarity (cf. FIG. 10), i.e. groups vi and viii, are selected consecutively, and so on. Referring to FIG. 12, it can be seen that the resulting applied data voltage polarity for column 1 (reference numeral 78) against time (t) requires the polarity to be switched only every second time a new group is selected, thus conserving half the power consumed in the prior art arrangement by switching polarity.

In this embodiment (FIG. 12), the number of successive groups of rows being driven with the same polarity that are selected consecutively is two (e.g. group i and group iii). However, as with the single row embodiments described in relation to the FIG. 5 inversion scheme, in other embodiments, this number may be chosen to be more than two, as required. Again, the larger the number, the less often the polarity needs to be switched per column, and hence the greater the power saving. However, the same trade-offs as described earlier are again involved, and hence correspondingly the number of successive groups of rows being driven with the same polarity that are selected consecutively may be chosen as required by the skilled person in view of these trade-offs according to the particular circumstances under consideration. Again in correspondence to the earlier described “single row” embodiments, one preferred alternative embodiment is one in which the number of successive groups of rows being driven with the same polarity that are selected consecutively is four. This provides an overall four-fold power saving without significantly introducing moving image artefacts.

Although the inversion schemes shown in FIGS. 5 and 10 are the most commonly used schemes to which the present invention may be applied, nevertheless the invention may be embodied in other schemes as required, by considering as groups all consecutively numbered rows being driven with the same polarity data voltage. Thus, if, say, the invention is to be embodied in an inversion scheme in which the first four rows (by number/position) are positively driven, then the next four rows (by number/position) are negatively driven, then each group will comprise four such consecutively numbered rows.

The invention may also be applied to other driving schemes in which different polarities are applied to different rows in a given column, whatever the reason this is done for and irrespective of whether the row polarity allocation is the same as any of those described above. For example, even if the number or rows in each group (as defined above) varies between positive and negative polarity, or indeed varies for different groups of the same polarity, the invention may still be implemented by selecting the rows over time by successively selecting consecutive groups of the same polarity.

Also, it is apparent from a comparison of FIG. 5 with FIG. 10, and likewise a comparison of FIG. 7 with FIG. 12, that a single row in a “single row by single row” inversion scheme is analogous to a group of rows in a “group of rows by group of rows” inversion scheme, and hence that embodiments such as those described with reference to FIGS. 7 and 9 may be considered as special cases of the FIG. 10 type embodiment, in which the number of rows in each group equals 1.

Finally, although the above embodiments have all been described in relation to a particular liquid crystal display device, it will be appreciated that the row selection of the present invention may also be applied in other liquid crystal display devices, and in other types of display devices requiring or potentially benefiting from inverted polarity column driving.

1. A method of driving an array of pixels arranged in rows (l-m) and columns (l-n); the method comprising:
selecting each of the rows of pixels one at a time;
applying a data voltage to each of the columns of pixels each time a row is selected, the polarity of the data voltage applied to a given column being inverted between a first polarity and a second polarity such that successive groups of rows, each comprising one row or plural successive rows, are driven with a different polarity of data voltage;
wherein selecting each of the rows of pixels one at a time comprises the following steps performed in the following order:
(i) successively selecting a first plurality of successive groups of those rows being driven with the first polarity;
(ii) successively selecting a first plurality of successive groups of those rows being driven with the second polarity; and
(iii) repeating steps (i) and (ii) for at least one further plurality of successive groups of those rows being driven with the first polarity and at least one further plurality of successive groups of those rows being driven with the second polarity.

2. A method according to claim 1, wherein each group of rows comprises only one row.

3. A method according to claim 1, wherein the number of rows in each group is two.

4. A method according to any preceding claim, wherein the same polarity is applied to each column for a given row.

5. A method according to any of claims 1 to 4, wherein a different polarity is applied to adjacent columns for a given row.

6. A method according to any preceding claim, wherein the number of successive groups of those rows being driven with a same polarity selected in succession is two.

7. A method according to any preceding claim, further comprising storing video data for rows whose selection is delayed compared to if the rows were selected in direct succession.

8. A method according to any preceding claim, wherein the pixels are pixels of an active matrix liquid crystal display.

9. Display driver apparatus for driving an array of pixels arranged in rows (l-m) and columns (l-n), comprising:
means for selecting each of the rows of pixels one at a time;
means for applying a data voltage to each of the columns of pixels each time a row is selected, such that the polarity of the data voltage applied to a given column is inverted between a first polarity and a second polarity such that successive groups of rows, each comprising one row or plural successive rows, are driven with a different polarity of data voltage;
wherein the means for selecting each of the rows of pixels one at a time is adapted to perform selection of the rows by implementing the following steps in the following order:
(i) successively selecting a first plurality of successive groups of those rows being driven with the first polarity;
(ii) successively selecting a first plurality of successive groups of those rows being driven with the second polarity; and
(iii) repeating steps (i) and (ii) for at least one further plurality of successive groups of those rows being driven with the first polarity and at least one further plurality of successive groups of those rows being driven with the second polarity.

10. A display device comprising an array of pixels arranged in rows and columns, and display driver apparatus according to claim 9.
